(19) United States
(12) Patent Application Publication
(10) Pub. No.: US 2025/0266695 A1
(43) Pub. Date: Aug. 21, 2025

(54) BATTERY DEVICE

(71) Applicant: ABLIC Inc., Nagano (JP)

(72) Inventor: Shinya FUKUCHI, Nagano (JP)

(73) Assignee: ABLIC Inc., Nagano (JP)

(21) Appl. No.: 19/023,178

(22) Filed: Jan. 15, 2025

(30) Foreign Application Priority Data
Feb. 20, 2024 (JP) 2024-023366
Sep. 17, 2024 (JP) 2024-160016

(51) Int. Cl. H02J 7/00

(52) U.S. Cl. CPC H02J 7/0031; H02J 7/00302; H02J 7/00304; H02J 7/00306; H02J 7/0047; H02J 7/0063

(57) ABSTRACT

A battery device having a charge-discharge path with which a sense resistor is connected in series. The battery device includes: a comparator, detecting an over-current from a voltage drop of the sense resistor during discharge; a control circuit, controlling a discharge control FET based on an output signal of the comparator; a comparator, detecting a voltage of an external negative electrode terminal; and a control circuit, based on an output signal of the comparator, returning to an over-current detection reference of a normal state from an over-charge state. When there is a disconnection between the charge-discharge control circuit and the charge control in the normal state during discharge, the comparator detects a change of the voltage of the external negative electrode terminal due to the voltage drop at a body diode of the charge control FET.

### CROSS-REFERENCE TO RELATED APPLICATION

This application claims the priority benefit of Japan application serial no. 2024-023366, filed on Feb. 20, 2024 and Japan application serial no. 2024-160016, filed on Sep. 17, 2024. The entirety of each of the above-mentioned patent applications is hereby incorporated by reference herein and made a part of this specification.

### BACKGROUND

### Technical Field

The present invention relates to a battery device.

### Description of Related Art

A battery device includes a charge-discharge control circuit that detects over-discharge, over-charge, and over-current to control charging and discharging in order to safely use a secondary battery, such as a lithium-ion battery, incorporated therein.

The charge-discharge control circuit can stop charging or discharging through performing ON/OFF control on two control field effect transistors (FETs), which are switching elements, connected to a charge-discharge path.

Specifically, in the case where over-discharge is detected, the discharge path from the secondary battery to the load is interrupted, and in the case where over-charging is detected, the charging path from the charger to the secondary battery is interrupted. Additionally, to detect over-current, there are devices that detect over-current in the charge-discharge path by detecting a voltage drop of a sense resistor connected in series with the charge-discharge path (see, for example, Japanese Laid-open No. 2009-77610, etc.)

The present invention provides a battery device that can detect a disconnection between a charge-discharge control circuit and a charge control FET in a normal state during discharge without increasing an analog circuit element.

### SUMMARY

A battery device according to an embodiment of the present invention is a battery device having a charge-discharge path with which a sense resistor is connected in series and provided with an external positive electrode terminal and an external negative electrode terminal. The battery device includes: a charge control field effect transistor (FET), in which a drain and a source are connected with the charge-discharge path and which includes a body diode in which a discharge direction of the charge-discharge path is a forward direction; a discharge control FET, in which a drain and a source are connected with the charge-discharge path; and a charge-discharge control circuit, performing ON/OFF control on the charge control FET and the discharge control FET. The charge/discharge control circuit includes: a current detection comparator, detecting a current flowing through the charge-discharge path from a voltage drop of the sense resistor; a discharge control circuit, based on an output signal of the current detection comparator, turning off the discharge control FET in response to determining that a state is a discharge over-current state, and turning ON the discharge control FET in response to determining that the state is not the discharge over-current state; an over-charge hysteresis reset detection comparator, detecting a voltage of a predetermined location of the charge/discharge path to determine that the state has returned from an over-charge state to a normal state; and an over-charge hysteresis reset control circuit, based on an output signal of the over-charge hysteresis reset detection comparator, returning to an over-current detection reference of the normal state from the over-charge state. In a case where there is a disconnection between the charge/discharge control circuit and the charge control FET in the normal state during discharge, the over-charge hysteresis reset detection comparator detects a change of a voltage of an external negative electrode terminal due to a voltage drop at the body diode of the charge/control FET and outputs a signal to the discharge control circuit.

### BRIEF DESCRIPTION OF THE DRAWINGS

FIG. 1 is a circuit diagram illustrating a battery device in a normal state during discharge according to a first embodiment of the present invention.

FIG. 2 is a circuit diagram illustrating the battery device in a case where there is a disconnection between a charge control circuit and a charge control FET in the normal state during discharge illustrated in FIG. 1.

FIG. 3 is a circuit diagram illustrating a battery device in a normal state during discharge according to a second embodiment of the present invention.

FIG. 4 is a circuit diagram illustrating the battery device in a case where there is a disconnection between a charge control circuit and a charge control FET in the normal state during discharge illustrated in FIG. 3.

FIG. 5 is a circuit diagram illustrating a battery device in a normal state during discharge according to a third embodiment of the present invention.

FIG. 6 is a circuit diagram illustrating the battery device in a case where there is a disconnection between a charge control circuit and a charge control FET in the normal state during discharge illustrated in FIG. 5.

FIG. 7 is a circuit diagram illustrating a conventional battery device having a charge-discharge path in which a sense resistor is connected in series.

### DESCRIPTION OF THE EMBODIMENTS

According to an aspect of the present invention, a battery device that can detect a disconnection between a charge-discharge control circuit and a charge control FET in the normal state during discharge without increasing an analog circuit element is provided.

The embodiment modes for implementing the present invention will be described in detail below with reference to the drawings. In the drawings, the same reference numerals are assigned to the same forming portions, and redundant explanations may be omitted.

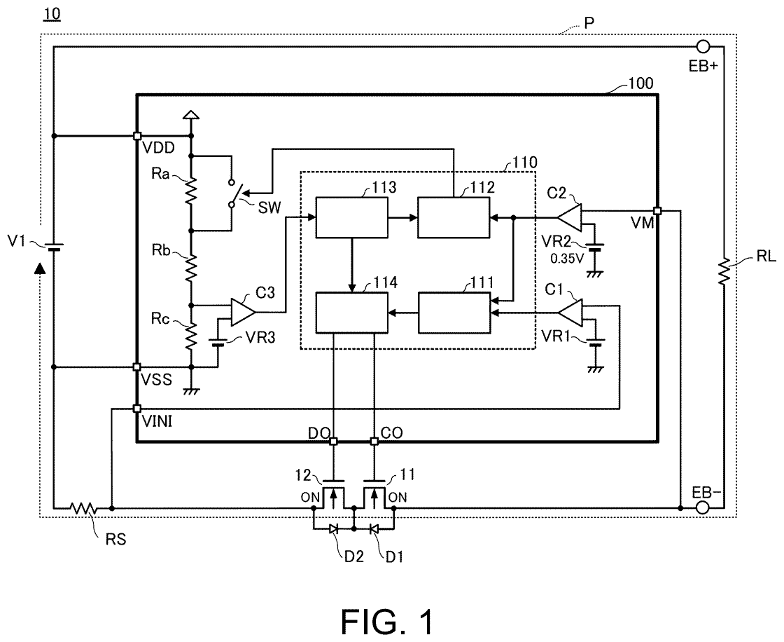

FIG. 1 is a circuit diagram illustrating a battery device in a normal state during discharge according to a first embodiment of the present invention.

As illustrated in FIG. 1, the battery device includes a secondary battery V1, a charge control field effect transistor (FET) 11, a discharge control FET 12, a sense resistor RS, a charge-discharge control circuit 100, an external positive electrode terminal EB+, and an external negative electrode terminal EB−.

During use (discharge) of the battery device 10, a load RL is connected between the external positive electrode terminal EB+and the external negative electrode terminal EB−. In addition, during charging of the battery device 10, a charger is connected between the external positive electrode terminal EB+and the external negative electrode terminal EB−.

On the charge-discharge path P of the secondary battery V1, the load RL, the charge control FET 11, the discharge control FET 12, and the sense resistor RS are connected in series in this order from the positive electrode to the negative electrode of the secondary battery V1. Additionally, the negative electrode of the secondary battery V1 is grounded.

The charge control FET 11, the discharge control FET 12, and the sense resistor RS are connected in series on the so-called low side (the negative electrode side of the secondary battery V1).

In the embodiment, the secondary battery V1 is a lithium-ion battery, but the present invention is not limited thereto, and the secondary battery V1 can be any rechargeable battery capable of charging and discharging.

The charge control FET 11 is an N-type metal-oxide-semiconductor (NMOS) transistor in which the drain and the source are connected to the charge-discharge path P. The charge control FET 11 has a gate connected to the charge-discharge control circuit 100, and is ON/OFF controlled by the control signal of the charge-discharge control circuit 100.

Additionally, the ON-resistance of the charge control FET 11 is in the mΩ order, and for a battery voltage of a lithium-ion battery, the voltage drop in the channel when the charge control FET 11 is ON becomes approximately 0.01V.

Furthermore, the charge control FET 11 structurally includes a body diode D1. In the body diode D1, the discharge direction of the charge-discharge path P is the forward direction (the direction of the dotted arrow in FIG. 1). The voltage drop at the body diode D1 is approximately 0.7V.

In the normal state during discharge, when the charge control FET 11 is turned OFF, the charge-discharge path P in the charge control FET 11 becomes the body diode D1. In other words, in the normal state during discharge, if there is a disconnection between the gate and the charge-discharge control circuit 100 when the charge control FET 11 is ON, the voltage drop in the charge control FET 11 changes from approximately 0.01V to approximately 0.7V.

In the embodiment, the change of voltage drop is detected by monitoring the voltage of the external negative electrode terminal EB− without adding a new analog circuit element to the conventional circuit.

The discharge control FET 12, similar to the charge control FET 11, is an NMOS transistor in which the drain and the source are connected to the charge-discharge path P. The discharge control FET 12 has a gate connected to the charge-discharge control circuit 100, and is ON/OFF controlled by the control signal of the charge-discharge control circuit 100.

In addition, the discharge control FET 12 structurally includes a body diode D2. In the body diode D2, the charging direction of the charge-discharge path P is the forward direction.

The sense resistor RS is a resistor element for detecting the current flowing through the charge-discharge path P, and is connected in series with the charge-discharge path P. The current detection is performed by detecting the voltage drop at the sense resistor RS.

The charge-discharge control circuit 100 detects the battery voltage of the secondary battery V1 and controls charge-discharge in response to the detected battery voltage.

Specifically, the charge-discharge control circuit 100 performs control to stop charging to the secondary battery V1 when the secondary battery V1 enters an “over-charge” state. Additionally, the charge-discharge control circuit 100 performs control to stop discharge from the secondary battery V1 when the secondary battery V1 enters an “over-discharge” state (low voltage state). Furthermore, the charge-discharge control circuit 100 performs control to stop discharge from the secondary battery V1 when the secondary battery V1 enters an “over-current” state.

Here, the “over-charge” state refers to a state where the battery voltage of the secondary battery V1 exceeds a predetermined over-charge detection voltage, and the time during which the battery voltage exceeds the over-charge detection voltage is longer than a predetermined time. Additionally, in the case where the battery voltage decreases below an over-charge release voltage within a predetermined time, the state returns to a “normal state”. Furthermore, to prevent unstable operation when the battery voltage oscillates in the vicinity of the over-charge detection voltage, the over-charge release voltage is set lower than the over-charge detection voltage to provide an “over-charge hysteresis voltage” (=over-charge detection voltage−over-charge release voltage) to stabilize the operation. Specifically, the over-charge detection voltage is set to 4.6V and the over-charge release voltage is set to 4.3V, for example.

The “over-discharge” state refers to a state where the battery voltage of the secondary battery V1 decreases below a predetermined over-discharge detection voltage, and the time during which the battery voltage is lower than the over-discharge detection voltage continues for a predetermined time or longer. Additionally, in the case where the battery voltage increases over an over-discharge release voltage within a predetermined time, the state returns to the “normal state”. Furthermore, to prevent unstable operation when the battery voltage oscillates in the vicinity of the over-discharge detection voltage, the over-discharge release voltage is set higher than the over-discharge detection voltage to provide an “over-discharge hysteresis voltage” (=over-discharge release voltage-over-discharge detection voltage) to stabilize the operation. Specifically, the over-discharge detection voltage is set to 2.5V and the over-discharge release voltage is set to 2.7V, for example.

The “normal state” refers to a state where the battery voltage of the secondary battery V1 is equal to or lower than the over-charge detection voltage and equal to or higher than the over-discharge detection voltage.

The charge-discharge control circuit 100 is connected in parallel with the secondary battery V1 and operates by using the secondary battery V1 as a power source.

The charge-discharge control circuit 100 includes comparators C1, C2, C3, reference voltage sources VR1, VR2, VR3, resistor elements Ra, Rb, Rc, a switching element SW, and a control logic circuit 110. Additionally, the charge-discharge control circuit 100 includes a positive electrode power supply terminal VDD, a negative electrode power supply terminal VSS, a discharge control terminal DO, a charge control terminal CO, an external negative voltage input terminal VM, and an over-current detection terminal VINI.

The positive electrode power supply terminal VDD is connected to the positive electrode of the secondary battery V1 and the external positive electrode terminal EB+.

A resistor element may also be connected in series between the positive electrode power supply terminal VDD and the secondary battery V1 to suppress the occurrence of electrostatic breakdown and power supply fluctuations.

The negative electrode power supply terminal VSS is connected to the negative electrode of the secondary battery V1 and the ground potential.

The charge control terminal CO and the discharge control terminal DO are connected to the gates of the charge control FET 11 and the discharge control FET 12, respectively, and control signals are output from the control logic circuit 110.

The external negative voltage input terminal VM is a terminal for detecting the voltage of the external negative electrode terminal EB− located upstream of the charge control FET 11 in the discharge direction. The external negative voltage input terminal VM is connected to one of the input terminals of the comparator C2 for over-charge hysteresis reset detection.

A resistor element may be connected in series between the external negative voltage input terminal VM and the external negative electrode terminal EB− to suppress the occurrence of electrostatic breakdown and the damage when a charger is connected in reverse.

The over-current detection terminal VINI is a terminal for detecting a voltage drop of the sense resistor RS in order to detect the current flowing through the charge-discharge path. For this purpose, the over-current detection terminal VINI is connected upstream of the sense resistor RS in the discharge direction. Additionally, the over-current detection terminal VINI is connected to one of the input terminals of the comparator C1 for detecting the discharge over-current state of the secondary battery V1.

The resistor elements Ra, Rb, and Rc are connected in series between the positive electrode power supply terminal VDD and the negative electrode power supply terminal VSS, and form a bleeder resistor circuit for dividing the battery voltage of the secondary battery V1. The switching element SW for providing the over-charge hysteresis voltage is connected in parallel with the resistor element Ra. A high potential side terminal of the resistor element Rc is connected to the input terminal of the comparator C3.

The comparator C1 is a current detection comparator for detecting the discharge over-current state of the secondary battery V1.

The comparator C1 has two input terminals connected to the over-current detection terminal VINI and the reference voltage source VR1, and compares the applied voltage (voltage drop) of the sense resistor RS with the reference voltage Vref1 of the reference voltage source VR1. Then, the comparator C1 outputs a signal of H-level or L-level to the control logic circuit 110 according to the comparison result.

The comparator C2 is an over-charge hysteresis reset detection comparator for providing an over-charge hysteresis voltage.

The comparator C2 has two input terminals connected to the external negative voltage input terminal VM and the reference voltage source VR2, and compares the voltage of the external negative electrode terminal EB− upstream of the charge control FET11 in the discharge direction and the reference voltage Vref2 of the reference voltage source VR2. Then, the comparator C2 outputs a signal of H-level or L-level to the control logic circuit 110 according to the comparison result.

The reference voltage Vref2 is 0.35V in the embodiment.

In the embodiment, while it is described that one of the input terminals of the comparator C2 is connected to the external negative voltage input terminal VM, the connection destination is not limited thereto. As long as the over-charge hysteresis reset control circuit 112, which will be described later, can determine as having returned from the over-charge state to the normal state, one of the input terminals of the comparator C2 may be connected to any predetermined location in the charge-discharge path P.

The comparator C3 is an over-charge detection comparator for detecting the over-charge state of the secondary battery V1.

The comparator C3 has two input terminals connected to the high potential side terminal of the resistor element Rc and the reference voltage source VR3, and compares the divided voltage Vd of the secondary battery V1 with the reference voltage Vref3 of the reference voltage source VR3. Then, the comparator C3 outputs a signal of H-level or L-level to the control logic circuit 110 according to the comparison result.

The control logic circuit 110 performs ON/OFF control of the switching element SW, the charge control FET11, and the discharge control FET12 based on the output signals from the comparators C1, C2, and C3. The control logic circuit 110 has lower current consumption than an analog circuit because it is a logic circuit.

In addition, the control logic circuit 110 also includes an over-current control circuit 111, an over-charge hysteresis reset control circuit 112, an over-charge control circuit 113, and an output control circuit 114.

The over-current control circuit 111 determines whether there is a discharge over-current based on the output signal from the comparator C1 for detecting the discharge over-current state. Then, the over-current control circuit 111 outputs a signal of H-level or L-level to the output control circuit 114 according to the determination result.

The over-charge hysteresis reset control circuit 112 determines whether the state has transitioned from the over-charge state to the normal state based on the control signal of the over-charge control circuit 113 and the output signal of the comparator C2. Then, the over-charge hysteresis reset control circuit 112 performs ON/OFF control on the switching element SW according to the determination result.

Specifically, when determining that there is an over-charge state based on the output signal of the over-charge control circuit 113, the over-charge hysteresis reset control circuit 112 outputs a control signal to turn ON the switching element SW. Then, when determining that the state has returned to the normal state according to the output signal of the comparator C2, the over-charge hysteresis reset control circuit 112 outputs a control signal to turn OFF the switching element SW.

Through the ON/OFF control of the switching element SW, the divided voltage received by the comparator C3 that detects the over-charge state changes, so the over-charge hysteresis voltage can be provided.

In the normal state, even if the over-charge hysteresis reset control circuit 112 determines that the state has returned to the normal state according to the output signal from the comparator C2, the over-charge hysteresis reset control circuit 112 does not output a control signal to the switching element SW.

The over-charge control circuit 113 determines whether the state is the over-charge state based on the output signal from the comparator C3. Then, the over-charge control circuit 113 outputs a signal of H-level or L-level to the output control circuit 114 and the over-charge hysteresis reset control circuit 112 according to the determination result.

The output control circuit 114 outputs a control signal via the discharge control terminal DO and the charge control terminal CO based on the output signals from the over-current control circuit 111 and the over-charge control circuit 113, and performs ON/OFF control on the charge control FET 11 and the discharge control FET 12.

Specifically, when a signal indicating the over-current state is output from the over-current control circuit 111 during discharge, the output control circuit 114 outputs a control signal via the discharge control terminal DO to turn OFF the discharge control FET 12.

In addition, when a signal indicating the over-charge state is output from the over-charge control circuit 113 during charging, the output control circuit 114 outputs a control signal via the charge control terminal CO to turn OFF the charge control FET 11.

In the normal state during both discharge and charge, the output control circuit 114 outputs control signals to turn ON both of the charge control FET 11 and the discharge control FET 12.

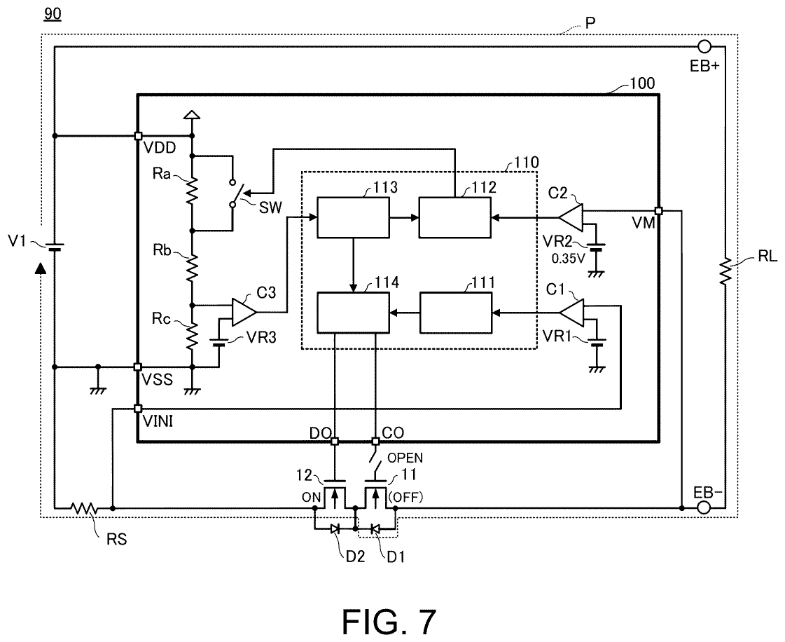

So far, for the battery device 10 of the embodiment, functions same as those of the conventional battery device 90 illustrated in FIG. 7 are described.

In a conventional battery device that performs over-current protection by using a sense resistor, in the case where there is a disconnection between the charge-discharge control circuit and the charge control FET during discharge, discharge cannot be stopped because the discharge over-current detection voltage is not detected at the external negative voltage input terminal VM. Thus, it is necessary to monitor the voltage generated at the body diode D1 in the external negative voltage input terminal VM. However, adding an analog circuit such as a comparator for monitoring increases both chip area as well as current consumption.

Thus, in the first embodiment of the present invention, the comparator C2, which is provided to set the over-charge hysteresis voltage, is utilized also for detecting a disconnection between the charge-discharge control circuit and the charge control FET. The output signal of the comparator C2 is output to the over-current control circuit 111.

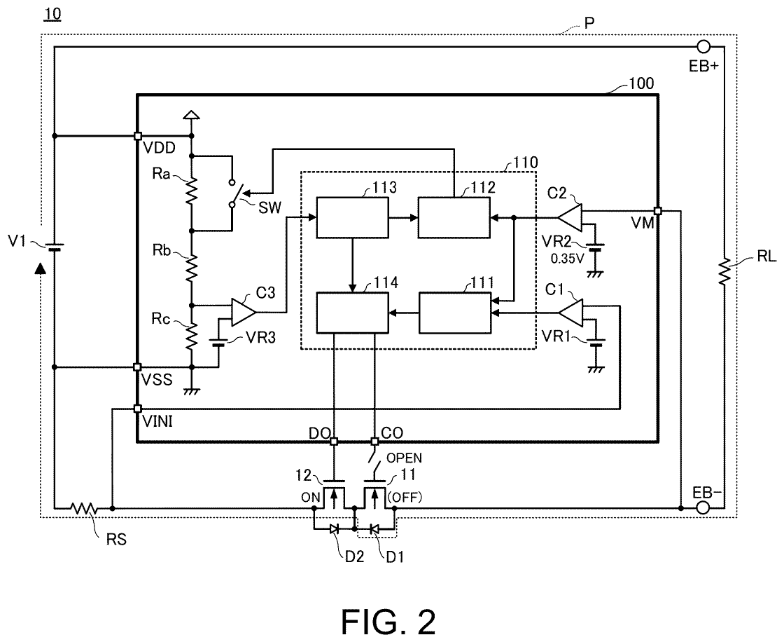

FIG. 2 is a circuit diagram illustrating the battery device in a case where there is a disconnection between the charge control circuit and the charge control FET in the normal state during discharge illustrated in FIG. 1.

As illustrated in FIG. 2, in the case where there is a disconnection between the charge-discharge control circuit 100 and the charge control FET 11 in the normal state during discharge, the charge control FET 11 is turned OFF unintentionally. As a result, the current flowing through the drain and the source of the charge control FET 11 flows from the channel having a low ON-resistance to the body diode D1. Consequently, the voltage drop of the charge control FET 11 changes from approximately 0.01V to approximately 0.7V, causing the voltage at the external negative voltage input terminal VM to increase. Since the reference voltage Vref2 received by the comparator C2 is 0.35V, the output signal of the comparator C2 changes from L-level to H-level.

By such utilization, with the comparator C2 outputting the output signal to the over-current control circuit 111 as well, the over-current control circuit 111 can detect the disconnection with the charge control FET 11. Then, the over-current control circuit 111, which has detected the disconnection, turns OFF the discharge control FET 12 through the output control circuit 114 to stop the discharge.

In this way, the battery device 10 of the embodiment can detect a disconnection between the charge-discharge control circuit 100 and the charge control FET 11 in the normal state during discharge without adding an analog circuit such as a comparator.

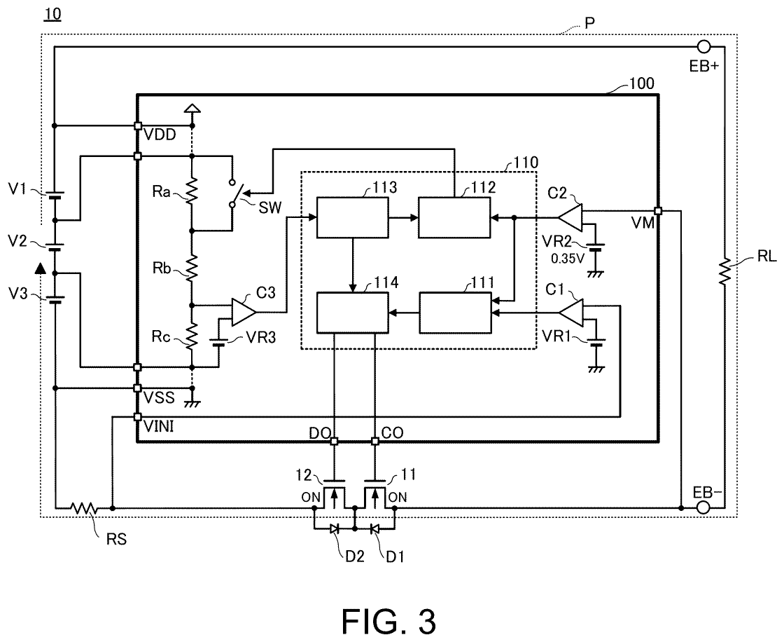

FIG. 3 is a circuit diagram illustrating a battery device in a normal state during discharge according to a second embodiment of the present invention.

The second embodiment is the same as the first embodiment, except that the single secondary battery V1 is replaced with three secondary batteries V1, V2, V3, and each of the secondary batteries V1, V2, V3 is connected to the charge-discharge control circuit 100.

In FIG. 3, the charge-discharge control circuits 100 connected to secondary batteries other than the secondary battery V2 are omitted from the illustration.

Furthermore, as mentioned earlier, the same reference numerals are assigned to the same forming portions as in the first embodiment, and redundant descriptions are omitted.

As illustrated in FIG. 3, the secondary battery V2 is connected to the charge-discharge control circuit 100 and thus under charge-discharge control performed by the charge-discharge control circuit 100. In the normal state during discharge, the charge-discharge control circuit 100 turns ON both the charge control FET 11 and the discharge control FET 12.

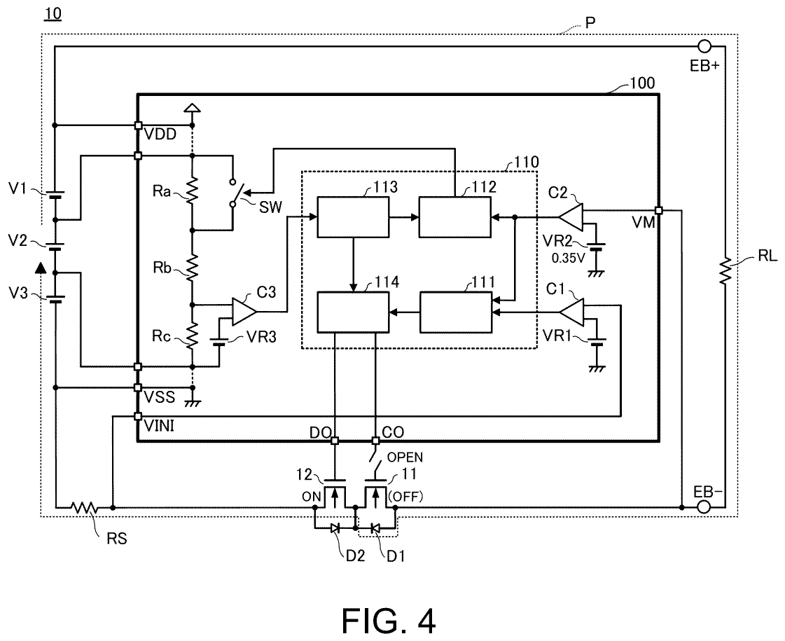

FIG. 4 is a circuit diagram illustrating the battery device in a case where there is a disconnection between the charge control circuit and the charge control FET in the normal state during discharge illustrated in FIG. 3.

As illustrated in FIG. 4, similar to the first embodiment, when there is a disconnection between the charge-discharge control circuit 100 and the charge control FET 11 in the normal state during discharge, the charge control FET 11 is turned OFF unintentionally. As a result, the current flowing through the drain and the source of the charge control FET 11 flows from the channel having a low ON-resistance to the body diode D1. Consequently, the voltage drop of the charge control FET 11 changes from approximately 0.01V to approximately 0.7V, causing the voltage at the external negative voltage input terminal VM to increase. Since the reference voltage Vref2 received by the comparator C2 is 0.35V, the output signal of the comparator C2 changes from L-level to H-level.

By such utilization, with the comparator C2 outputting the output signal to the over-current control circuit 111 as well, the over-current control circuit 111 can detect the disconnection with the charge control FET 11. Then, the over-current control circuit 111, which has detected the disconnection, turns OFF the discharge control FET 12 through the output control circuit 114 to stop the discharge.

In this way, even in the second embodiment where multiple secondary batteries are connected, it is possible to detect a disconnection between the charge-discharge control circuit 100 and the charge control FET 11 in the normal state during discharge without adding an analog circuit such as a comparator.

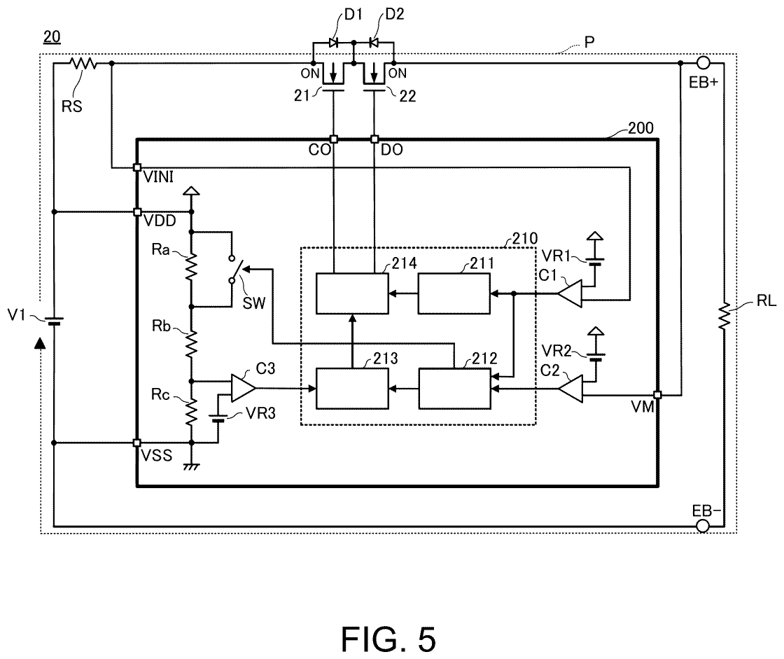

FIG. 5 is a circuit diagram illustrating a battery device in a normal state during discharge according to a third embodiment of the present invention.

The third embodiment is identical to the first embodiment, except that the charge control FET 11, the discharge control FET 12, and the sense resistor RS are connected in series on the so-called high side (positive electrode side of the secondary battery V1), and the various parts of the charge-discharge control circuit are arranged accordingly.

The battery device 20 of the third embodiment includes a charge control FET 21, a discharge control FET 22, the sense resistor RS, a charge-discharge control circuit 200, the external positive electrode terminal EB+, and the external negative electrode terminal EB−.

Since the charge control FET 21 and the discharge control FET 22 are similar to the charge control FET 11 and the discharge control FET 12 in the first embodiment, the description of the functions thereof are omitted.

The charge-discharge control circuit 200 is similar to the charge-discharge control circuit 100 in terms of the function for detecting the battery voltage of the secondary battery V1 and controlling charge-discharge based on the detected battery voltage.

The external negative voltage input terminal VM detects the voltage of the external positive electrode terminal EB+downstream of the discharge control FET 22 in the discharge direction.

The over-current detection terminal VINI is connected downstream of the sense resistor RS in the discharge direction.

The control logic circuit 210 also includes an over-current control circuit 211, an over-charge hysteresis reset control circuit 212, an over-charge control circuit 213, and an output control circuit 214.

Since the over-current control circuit 211, the over-charge hysteresis reset control circuit 212, the over-charge control circuit 213, and the output control circuit 214 are similar to the over-current control circuit 111, the over-charge hysteresis reset control circuit 112, the over-charge control circuit 113, and the output control circuit 114 in the first embodiment, the description of the functions thereof will be omitted in the following description.

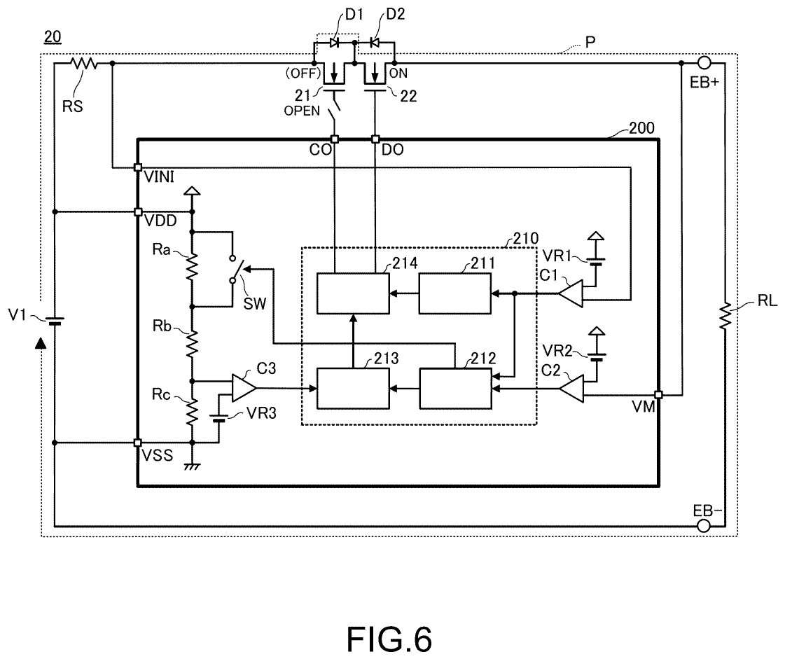

FIG. 6 is a circuit diagram illustrating the battery device in a case where there is a disconnection between the charge control circuit and the charge control FET in the normal state during discharge illustrated in FIG. 5.

As illustrated in FIG. 6, in the case where there is a disconnection between the charge-discharge control circuit 200 and the charge control FET 21 in the normal state during discharge, the charge control FET 21 is turned OFF unintentionally. As a result, the current flowing through the drain and the source of the charge control FET 21 flows from the channel having a low ON-resistance to the body diode D1. Consequently, the voltage drop of the charge control FET 21 changes from approximately 0.01V to approximately 0.7V, causing the voltage at the external negative voltage input terminal VM to increase. Since the reference voltage Vref2 received by the comparator C2 is 0.35V, the output signal of the comparator C2 changes from L-level to H-level.

By such utilization, with the comparator C2 outputting the output signal to the over-current control circuit 211 as well, the over-current control circuit 211 can detect the disconnection with the charge control FET 21. Then, the over-current control circuit 211, which has detected the disconnection, turns OFF the discharge control FET 22 through the output control circuit 214 to stop the discharge.

In this way, the battery device 20 of the embodiment can detect a disconnection between the charge-discharge control circuit 200 and the charge control FET 21 in the normal state during discharge without adding an analog circuit such as a comparator.

As described above, the battery device in an embodiment of the present invention includes the charge-discharge path with which the sense resistor is connected in series and provided with an external positive electrode terminal and an external negative electrode terminal. The battery device includes the charge control FET in which the drain and the source are connected to the charge-discharge path and which has the body diode in which the discharge direction of the charge-discharge path is the forward direction, and the discharge control FET with having the drain-source connected to the charge-discharge path. Additionally, the battery device includes the charge-discharge control circuit that performs ON/OFF control on the charge control FET and the discharge control FET. This charge-discharge control circuit includes the current detection comparator that detects the current flowing on the charge-discharge path from the voltage drop of the sense resistor, and the discharge control circuit that determines whether the state is the discharge over-current state based on the output signal of the current detection comparator and performs ON/OFF control on the discharge control FET. Furthermore, the charge-discharge control circuit includes the over-charge hysteresis reset detection comparator that detects the voltage at a predetermined location in the charge-discharge path to determine whether the state has returned from the over-charge state to the normal state, and a control circuit that returns to the over-current detection reference of the normal state based on the output signal of the over-charge hysteresis reset detection comparator.

The over-charge hysteresis reset detection comparator detects a change of the voltage of the external negative electrode terminal due to the voltage drop at the body diode of the charge control FET that is unintentionally turned off in the normal state during discharge, and also outputs a signal to the discharge control circuit. The discharge control circuit, upon receiving the output signal from the over-charge hysteresis reset detection comparator, functions as a disconnection detection circuit and detects a disconnection between the charge-discharge control circuit and the charge control FET. Then, the over-current control circuit that has detected a disconnection turns off the discharge control FET through the output control circuit to stop the discharge, thereby enabling safe control of charge and discharge.

In this way, the battery device of the embodiment can detect a disconnection between the charge-discharge control circuit and the charge control FET in the normal state during discharge without adding an analog circuit such as a comparator. Furthermore, since the processing is performed by using existing logic circuits without requiring an analog circuit with high current consumption even with the addition of a disconnection detection function, it is possible to suppress the increase in chip area and current consumption.

The present invention has been described with respect to an embodiment, but the present invention is not limited to the embodiment and various modifications are possible within the scope that does not deviate from the spirit of the present invention.

For example, while an embodiment with a single secondary battery has been described, the present invention can also be applied to cases with multiple secondary batteries.

What is claimed is:

1. A battery device, having a charge-discharge path with which a sense resistor is connected in series and provided with an external positive electrode terminal and an external negative electrode terminal, the battery device comprising:
a charge control field effect transistor (FET), in which a drain and a source are connected with the charge-discharge path and which comprises a body diode in which a discharge direction of the charge-discharge path is a forward direction;
a discharge control FET, in which a drain and a source are connected with the charge-discharge path; and
a charge-discharge control circuit, performing ON/OFF control on the charge control FET and the discharge control FET,
wherein the charge/discharge control circuit comprises:
a current detection comparator, detecting a current flowing through the charge-discharge path from a voltage drop of the sense resistor;
a discharge control circuit, based on an output signal of the current detection comparator, turning off the discharge control FET in response to determining that a state is a discharge over-current state, and turning ON the discharge control FET in response to determining that the state is not the discharge over-current state;
an over-charge hysteresis reset detection comparator, detecting a voltage of a predetermined location of the charge/discharge path to determine that the state has returned from an over-charge state to a normal state; and
an over-charge hysteresis reset control circuit, based on an output signal of the over-charge hysteresis reset detection comparator, returning to an over-current detection reference of the normal state from the over-charge state,
wherein, in a case where there is a disconnection between the charge/discharge control circuit and the charge control FET in the normal state during discharge, the over-charge hysteresis reset detection comparator detects a change of a voltage of the external negative electrode terminal due to a voltage drop at the body diode of the charge/control FET and outputs a signal to the discharge control circuit.

2. The battery device as claimed in claim 1, wherein, when receiving an output signal from the over-charge hysteresis reset detection comparator detecting the change of the voltage of the external negative electrode terminal due to the voltage drop at the body diode, the discharge control circuit outputs a signal that turns off the discharge control FET.
